(19) United States
(12) Patent Application Publication
(10) Pub. No.: US 2007/0289255 A1
(43) Pub. Date: Dec. 20, 2007

(54) APPARATUS FOR PACKAGING ITEMS IN A CARTON AND RELATED METHODS

(75) Inventor: Jerome Brugger, Melbourne, KY (US)

Correspondence Address: WOOD, HERRON & EVANS, LLP, 2700 CAREW TOWER, 441 VINE STREET, CINCINNATI, OH, 45202, US

(73) Assignee: R.A. JONES & CO., INC., Covington, KY (US)

(21) Appl. No.: 11/760,027

(22) Filed: Jun. 8, 2007

Related U.S. Application Data
(60) Provisional application No. 60/811,858, filed on Jun. 8, 2006.

(51) Int. Cl. B26D 7/27

(52) U.S. Cl. 53/396

(57) ABSTRACT

An apparatus for transferring and reorienting an item for packaging into a carton includes a body having a first end and a second end and a channel formed in the body. The channel defines a channel axis extending between the first and second ends and is configured to receive the item at the first end when the item is in a first angular orientation. The channel is configured to deliver the item at the second end in a second angular orientation relative to the channel axis that is different from the first angular orientation. The channel may include a helical groove extending between the first and second ends and formed in a wall of the channel which operates as a track for rotating the item as it moves between the first and second ends. A method of packaging an item includes transporting an item through the apparatus so as to orient the item relative to the carton.

### CROSS REFERENCE TO RELATED APPLICATIONS

This application claims priority to provisional patent application Ser. No. 60/811,858 filed on Jun. 8, 2006, the disclosure of which is expressly incorporated by reference herein in its entirety.

### FIELD OF THE INVENTION

This invention relates to packaging of items in a carton and, more particularly, to packaging of items that require reorientation for packaging in a carton in a desired configuration.

### BACKGROUND OF THE INVENTION

In the field of packaging, items are often provided to the consumer by providing a stacked configuration of the items within a suitable carton. It is common to find several individually packaged items within the same carton such that the consumer may remove the items from the carton one at a time. By way of example, various products, such as tea, coffee, etc., may be provided in individual packs and arranged in a stacked configuration within a carton. The carton typically includes a scored panel that defines a dispenser adjacent a bottom end of the carton such that upon removal of the panel, the bottom-most pack is exposed. The consumer may then simply remove one of the packs from the dispenser. Upon doing so, the remaining packs in the stack drop down to expose another pack. This process may continue until the last pack from the stack is removed from the carton.

One such package for products such as tea, coffee and other products that has gained recent acceptance in the industry is a blister pack. Blister packs include a generally cylindrical body defining a cavity with an opening for accessing the cavity. The opening includes an upper flange thereabouts and a cover, such as a suitable foil or other material known to those of ordinary skill in the art, adhesively applied thereto to seal the opening and retain the various products in the cavity. The upper flange typically includes a projecting tab that provides a grasping surface for the consumer as well as an initiation point for removing the cover from the body of the blister pack in order to gain access to the product therein. While facilitating enhanced use of the blister pack by the consumer, the projecting tab presents some challenges in packaging the blister packs.

For instance, stacks of the blister packs may be packaged in a generally rectangular carton. To minimize the amount of material used in the carton, the cartons may have sidewalls that are spaced just slightly larger than the diameter of the blister packs. Consequently, to fit the blister packs, including their projecting tabs, within the carton, the tabs must be oriented so as to be positioned in a corner region of the carton. Conventional automated packaging machines that provide product reorientation may be complex mechanical devices that include a relatively large number of movable parts dedicated to turning the product. Such complex mechanical devices and the large number of parts associated therewith require regular maintenance and/or replacement and are also costly to operate.

Accordingly, it has been one objective of the invention to provide an improved apparatus and method for packaging items within a carton in a desired orientation.

It has been a further objective of the invention to provide improved apparatus and methods for packaging items within a carton in a desired orientation in a simplified, cost-effective manner.

It has been a further objective of the invention to provide apparatus and methods for packaging items within a carton in a desired orientation that may be used in an automated packaging process.

### SUMMARY OF THE INVENTION

In one embodiment, an apparatus for transferring and reorienting a blister pack for packaging into a carton includes a body having a first end and a second end and a channel formed in the body. The channel defines a channel axis extending between the first and second ends. The channel is configured to receive the blister pack when the blister pack is in a first angular orientation relative to the channel axis. The channel is configured to deliver the blister pack in a second angular orientation relative to the channel axis that is different from the first angular orientation.

The channel may include a groove extending between the first and second ends and formed in a wall of the channel. The groove is configured to engage a projecting tab of the blister pack and rotate the blister pack from the first angular orientation to the second angular orientation as the blister pack moves from the first end to the second end. The groove may also be configured to engage a generally downward-pointing projecting tab of the blister pack at the first end. In one embodiment, the groove is further configured to rotate the blister pack about 45 degrees as the blister pack travels from the first end to the second end.

In another embodiment, a handling apparatus for transporting, reorienting and transferring a stack of blister packs to a carton includes a bucket configured for movement in a machine direction. The bucket includes a bucket channel having an axis substantially perpendicular to the machine direction. The bucket channel is configured to receive the stack of blister packs therein with the blister packs being in a first angular orientation. A loading guide is disposed between the bucket and the carton and includes a first end adjacent the bucket and a second end adjacent the carton. A loading guide channel extends between the first and second ends. The loading guide channel is configured to receive the stack of blister packs from the bucket at the first end when the blister packs are in the first angular orientation and deliver the blister packs to the carton at the second end in a second orientation that is different from the first angular orientation.

The bucket channel may include a cross-sectional shape that at least in part corresponds to a shape of the blister pack. Likewise, the loading guide channel may include a cross-sectional shape that substantially corresponds to a shape of the blister pack. The cross-sectional shape at the first end may correspond to the shape of the blister pack when the blister pack is in the first angular orientation. A groove may be formed in a wall of the loading guide channel and be configured to engage a projecting tab of the blister packs. The groove is configured to rotate the blister packs about the loading guide channel axis from the first angular orientation to the second angular orientation as the blister packs move from the first end to the second end. The handling apparatus may also include a notch in the bucket that extends generally in a second direction transverse to the machine direction, as well as a side guide received within the notch and configured to provide lateral support to the stack of blister packs in the bucket. The side guide may be adjustable within the notch and along the second direction to accommodate various sizes of the stack of blister packs in the bucket. In one embodiment, a pusher may be configured to advance the blister pack along the bucket channel and into the carton.

In another embodiment, an apparatus is configured for transferring and reorienting an item for packaging into a carton. The apparatus includes a body having a first end and a second end, as well as a channel formed in the body. The channel defines a channel axis and extends between the first and second ends. The channel is configured to receive the item at the first end when the item is in a first angular orientation relative to the channel axis. The channel is configured to deliver the item at the second end in a second angular orientation relative to the axis that is different from the first angular orientation.

In another embodiment, a method of handling a blister pack for packaging into a carton includes depositing the blister pack into a bucket configured to move in a machine direction. The bucket is moved in the machine direction and the blister pack is moved in a second direction along an axis transverse to the machine direction through a loading guide in operative communication with the bucket and the carton. The blister pack is reoriented from a first angular orientation relative to the axis to a second angular orientation relative to the axis that is different from the first angular orientation as the blister pack moves from a first end of the loading guide to a second end thereof.

In yet another embodiment, a method of handling an item for packaging into a carton includes depositing the item into a bucket configured to move in a machine direction. The bucket is moved in the machine direction and the item is moved in a second direction along an axis transverse to the machine direction through a loading guide in operative communication with the bucket and the carton. The item is reoriented from a first angular orientation relative to the axis to a second angular orientation relative to the axis that is different from the first angular orientation as the item moves from a first end of the loading guide to a second end thereof.

### BRIEF DESCRIPTION OF THE DRAWINGS

The accompanying drawings, which are incorporated in and constitute a part of this specification, illustrate embodiments of the invention and, together with the detailed description given below, serve to explain the invention.

FIG. 1 is a perspective view of an exemplary bucket in accordance with the principles of the invention;

FIG. 2 is a side elevation view of an exemplary blister pack to be used in embodiments of the invention;

FIG. 2A is a top plan view of the blister pack shown in FIG. 2;

FIG. 3 is a left side elevation view of the bucket shown in FIG. 1, including a tamp being mounted on top of the bucket;

FIG. 4 is an illustrative front elevation view of a process for loading a stack of blister packs from a bucket, through a loading guide, and into a carton;

FIG. 5 is a perspective view of the bucket and loading guide illustrated in FIG. 4;

FIG. 6 is a perspective cross-sectional view of the bucket and loading guide shown in FIG. 5;

FIG. 7 is a front elevation view of an embodiment of a loading guide in accordance with the principles of the invention;

FIG. 7A is a left side view of the loading guide shown in FIG. 7;

FIG. 7B is a cross-sectional view of the loading guide shown in FIG. 7 taken generally along line 7B-7B thereof;

FIG. 7C is a cross-sectional view of the loading guide shown in FIG. 7 taken generally along line 7C-7C thereof;

FIG. 7D is a right side view of the loading guide shown in FIG. 7; and

FIG. 8 is a left side view of a carton with the blister packs positioned therein.

### DETAILED DESCRIPTION

Various embodiments of the invention are directed to apparatus and methods of packaging items in a carton in a desired orientation that overcomes the drawbacks of current packaging machines. In particular, embodiments of the invention are directed to apparatus and methods of reorienting a stack of items such as blister packs for insertion into a carton at a desired orientation. As is known in the art, consumer products are provided to the consumer through an assembly line type of process including various stations that perform one or more functions in the overall process. For instance, one station may be a filling station that fills a receptacle (e.g., blister pack, pouch, etc.) with product; another station may seal the receptacle; another station may package the receptacle within a larger package (e.g., carton); and another station may seal the larger package. Each station may be associated with various apparatus for accomplishing the desired task.

The embodiments herein described are directed to apparatus and methods of packaging items within a carton, and more specifically, to packaging a stack of blister packs within a carton. Other apparatus that form no part of the present invention fill and seal the blister packs. These apparatus may provide a plurality of filled and sealed blister packs organized in a “shingle” to a conveyor system that delivers the blister packs to the packaging station on the assembly line. While embodiments of the invention are shown and described for packaging a stack of blister packs in a carton, these are merely illustrative and not intended to be limiting, as those of ordinary skill in the art will recognize that other items may benefit from the principles shown herein.

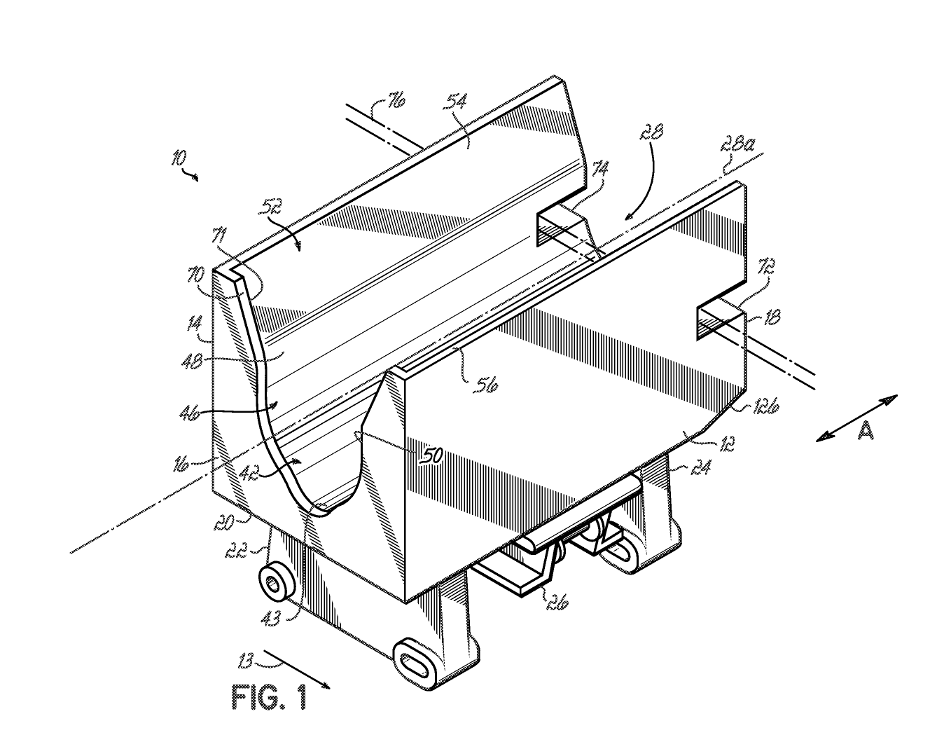

A handling apparatus in accordance with one embodiment includes a bucket conveyor having one or more buckets. Each of the buckets has a groove for receiving one or more blister packs such that a tab of a blister pack lies in the groove. The handling apparatus further includes one or more loading guides having a spirally-directed or helical groove for rotating the blister packs as they are pushed therethrough from the buckets and into cartons. The bucket conveyor comprises a plurality of individual buckets 10 movable in a machine direction (indicated by arrow 13). An exemplary embodiment of bucket 10 is shown in FIG. 1 and includes a front wall 12, a rear wall 14, sidewalls 16, 18, and a bottom wall 20. In one embodiment, a pair of carrying brackets 22, 24 are coupled to the bottom wall 20 and are provided with features for securing the buckets to parallel conveyor chains that further define the bucket conveyor (not shown). Alternatively, only a single bracket 26, as also shown in various figures, may be coupled to bottom wall 20 to secure the buckets 10 to a single conveyor chain on the bucket conveyor. Moreover, each of the buckets 10 is centered on the chain(s) at a desired pitch.

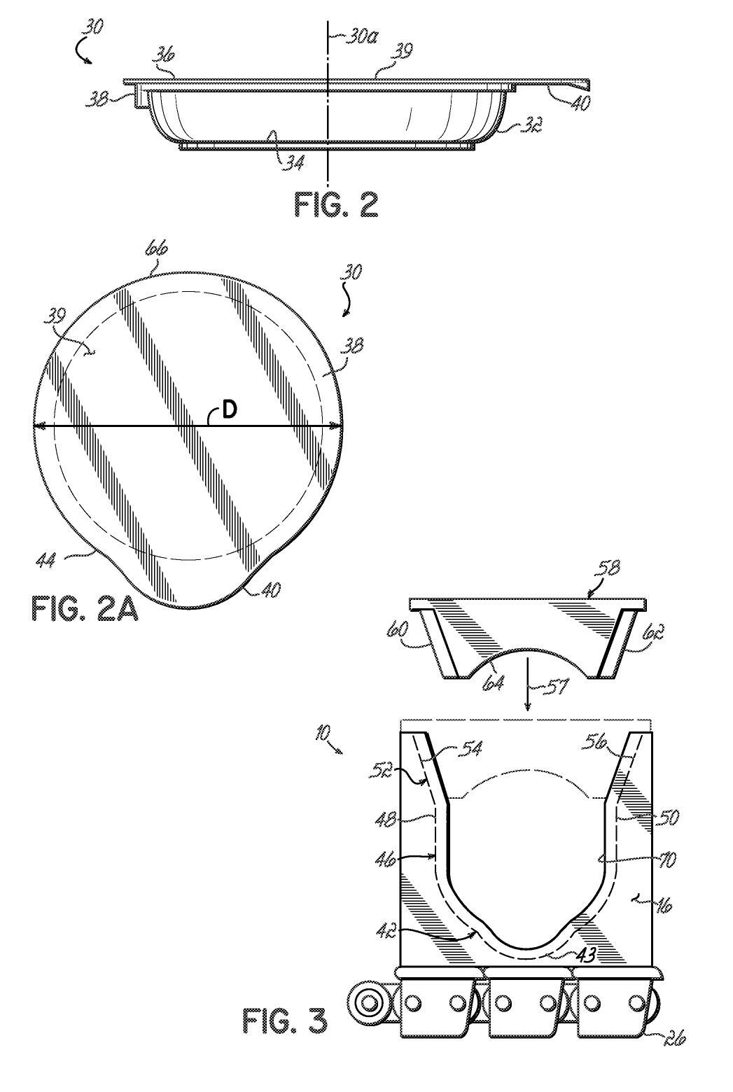

Each of the buckets 10 on the bucket conveyor includes a bucket channel 28 having an axis 28a and extending in a transverse direction substantially perpendicular to the machine direction. The channel 28 is configured to accommodate one or more blister packs 30 (FIG. 2), such as blister packs 30 arranged in a stacked configuration. FIGS. 2 and 2A illustrate an exemplary blister pack 30. As mentioned above, each blister pack 30 includes a generally cylindrical body 32 disposed about an axis 30a and defining a cavity 34 and an opening 36 for accessing the cavity 34. The opening 36 includes an upper flange 38 and a removable cover 39, such as a suitable foil, adhesively coupled to the upper flange 38 to retain product, such as tea, coffee and/or any of a wide variety of other products, in cavity 34. The upper flange 38 includes a projecting tab 40 that gives blister pack 30 a tear drop shape when viewed from above, as shown in FIG. 2A.

The usage of directional terms herein are for illustrative purposes and not intended to be limiting. More particularly, terms such as “upward,” “downward,” “lateral,” “vertical,” “horizontal,” “above,” “below,” “left,” “right,” “front,” and “back,” as well as terms derived from and/or related to these exemplary non-limiting terms may merely refer to orientations as shown in exemplary figures herein, such as to facilitate the description and understanding of details of depicted embodiments.

With reference to FIGS. 1 and 3, in order to confine the stack of blister packs 30 in buckets 10, the channel 28 has a lower portion 42 that conforms to the shape of the lower portion 44 of the blister pack 30 when the projecting tab 40 points downward (FIG. 2A). To this end, lower portion 42 includes a groove 43 adapted to closely receive the projecting tabs 40 of blister packs 30 therein. Channel 28 further includes an intermediate portion 46 above the lower portion 42 with substantially straight, vertical channel support walls 48, 50. Support walls 48, 50 are spaced apart by an amount substantially equal to the diameter D of the upper flange 38 of blister packs 30 (FIG. 2A). Channel 28 also includes an upper portion 52 with a pair of diverging channel support walls 54, 56. The upper portion 52 of the channel 28 is adapted to receive, as indicated by arrow 57, a tamp 58 having a pair of converging walls 60, 62 that respectively engage diverging support walls 54, 56 in upper portion 52, and a generally arcuate bottom wall 64 configured to engage an upper portion 66 (FIG. 2A) of the blister packs 30 to confine the stack of blister packs 30 from above. With this particular assembled configuration of bucket 10 and tamp 58 (shown in phantom in FIG. 3), the blister packs 30 are prevented from rotating about axis 28a of the channel 28 due to the asymmetry caused by projecting tab 40 and the manner in which projecting tab 40 is closely received in groove 43 of lower portion 42 of channel 28. Additionally, the tamp 58 prevents any movement of the blister packs 30 in a vertical direction by engagement of the upper portion 66 of the blister packs 30 with the bottom wall 64 of tamp 58.

In one exemplary aspect of this embodiment, all the blister packs 30 are deposited into the buckets 10 with the projecting tabs 40 in the downward facing direction and within groove 43, such that the stacked blister packs 30 are uniformly oriented within the buckets 10. Although the blister packs 30 may be deposited in the buckets 10 in any known manner, known seal apparatus may be configured to deliver the blister packs 30 to a next station in the assembly line with the projecting tabs 40 oriented in the downward position. Moreover, the downward projecting tab position may be desirable for other reasons, such as providing stability to the blister packs 30 during transportation thereof. Thus, fill and seal apparatus may be configured to drop a specific number of blister packs 30, for example, anywhere between about 5 and about 15 blister packs 30, into a bucket 10 with the projecting tabs 40 facing downward. Alternatively, however, the blister packs 30 may be deposited into the buckets 10 in any other orientation. Further, the number of blister packs 30 may also be greater or less than the illustrative range noted above, depending on the specific application.

While the blister packs 30 deposited in buckets 10 are prevented from rotation about axis 28a and from vertical movement by tamp 58, the blister packs 30 may slide along the channel 28 in the transverse direction (i.e., generally parallel to axis 28a). For instance, it may be desired that each of the blister packs 30 be substantially perpendicular to the channel 28 (e.g., where axis 28a is substantially coaxial and/or parallel with axis 30a). Unless constrained in the transverse direction, it may be possible for the blister packs 30 to slip along channel 28 such that the blister packs 30 are no longer perpendicular to the channel 28, but instead form an acute angle with respect to the channel 28 (i.e., axes 28a and 30a are no longer substantially parallel).

To prevent such transverse movement of the blister packs 30 in a bucket 10, sidewall 16 includes a lip 70 that projects into channel 28 by a relatively small amount. Lip 70 provides a bearing surface 71 adapted to engage the upper flange 38 of an end blister pack 30 adjacent lip 70. Accordingly, lip 70 prevents the blister packs 30 from falling out of channel 28 through sidewall 16 during normal operation or on the occasion that a transverse force is applied to the stack of blister packs 30 in bucket 10.

In another exemplary aspect of this embodiment, front and rear walls 12, 14 include notches 72, 74 extending from sidewall 18 toward opposed sidewall 16. Notches 72, 74 are configured to receive a stationary side guide 76 (shown in phantom in FIG. 1) associated with the bucket conveyor along which the buckets 10 travel. The side guide 76 may be adjustably positioned along the extending direction of notches 72, 74, as shown by arrow A in FIG. 1, so as to engage a blister pack 30 adjacent sidewall 18 and provide lateral support to the stack of blister packs 30 in bucket 10. The position of the side guide 76 may be determined by the number of blister packs 30 deposited in buckets 10. For instance, for a specific number of blister packs 30 (e.g., about 15) in buckets 10, side guide 76 may be positioned more adjacent sidewall 18. For fewer blister packs 30 (e.g., about 5), the side guide 76 is positioned in notches 72, 74 relatively closer to sidewall 16 so as to engage an end blister pack 30 closest sidewall 18. Those of ordinary skill in the art will recognize that the length of notches 72, 74 is sufficient to provide lateral support for the range of blister packs that may be accommodated in buckets 10. The lip 70 and side guide 76 effectively bound the stack of blister packs 30 therebetween to provide lateral support and prevent any undesired lateral movement of the stack of blister packs 30 (i.e., in the transverse direction). Those of ordinary skill in the art will further recognize that instead of using lip 70 to confine the blister packs 30 adjacent sidewall 16, a second side guide (not shown) could be alternatively used in a manner similar to side guide 76.

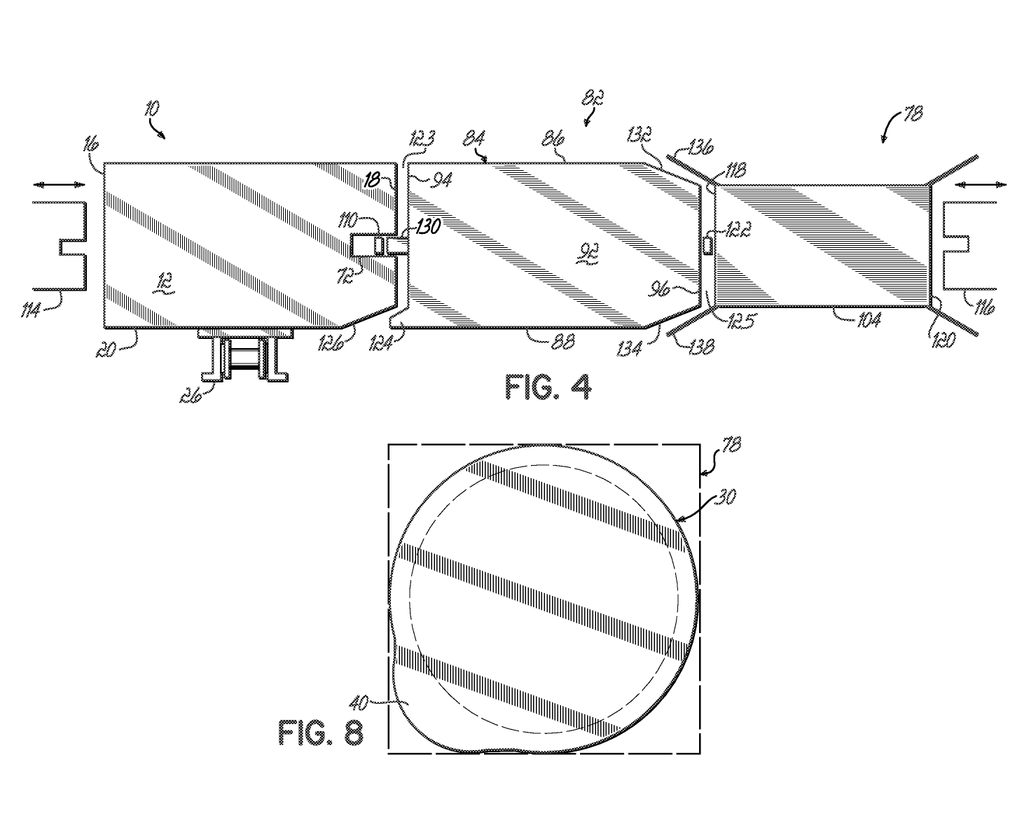

The blister packs 30 are conveyed in the buckets 10 to a cartoning apparatus for moving the stack of blister packs 30 from the buckets 10 on the bucket conveyor into respective cartons. This cartoner may include carton feeding and erecting apparatus, a carton conveyor, one or more loading guides, and downstream carton handling apparatus including dust flap closing, gluing, flap closing, compression and other conveying apparatus for finishing the carton and feeding it to a product discharge end of the cartoner, where the cartons are discharged for bulk packaging and shipment. The cartoner may further include a carton feeder for feeding cartons onto a carton conveyor which transports at least partially erected cartons in the machine direction. For example, in the illustrative embodiment of FIG. 4, the cartons 78 are generally rectangular with a major end panel open so as to receive the stack of blister packs 30 from buckets 10.

It will be appreciated that the cartoner also includes one or more loading guides 82 interposed between the bucket conveyor and the carton conveyor. In an exemplary embodiment, there may be six such loading guides 82 separated from one another in the machine direction so as to correspond to a pitch defined by the position of the buckets 10 on the bucket conveyor. Those of ordinary skill in the art will recognize, however, that more or fewer loading guides 82 may be used depending on the particular application. In the exemplary embodiment, the loading guides are stationary and therefore do not move in registration with either the bucket conveyor or the carton conveyor. Consequently, the cartoner is configured for an intermittent type of loading operation of the cartons. Those of ordinary skill in the art will recognize that, alternatively, the loading guides 82 may be associated with a guide conveyor that is adapted to move in registration with the bucket conveyor and/or carton conveyor so that a continuous type of loading operation of the cartons may be achieved.

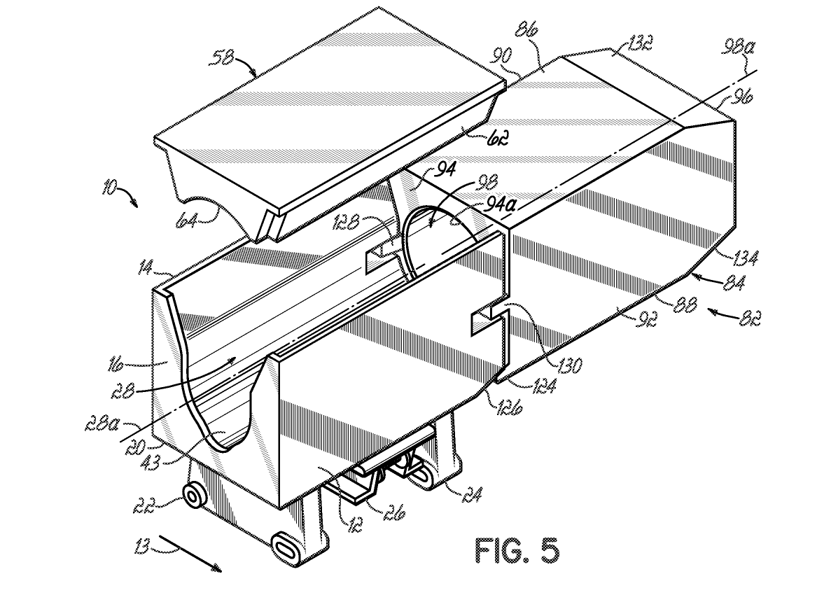

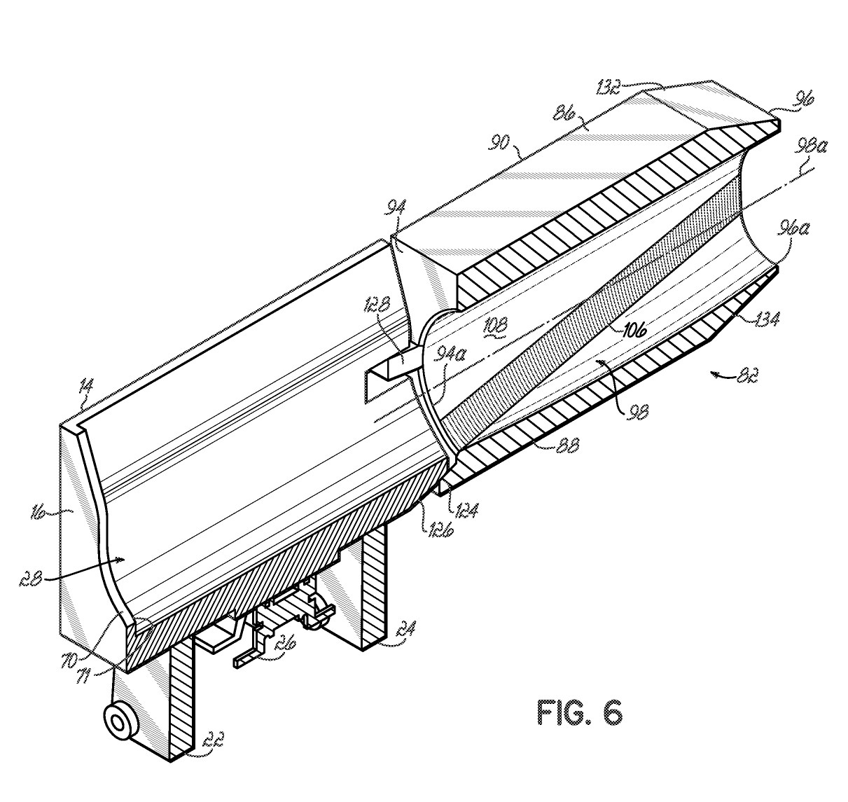

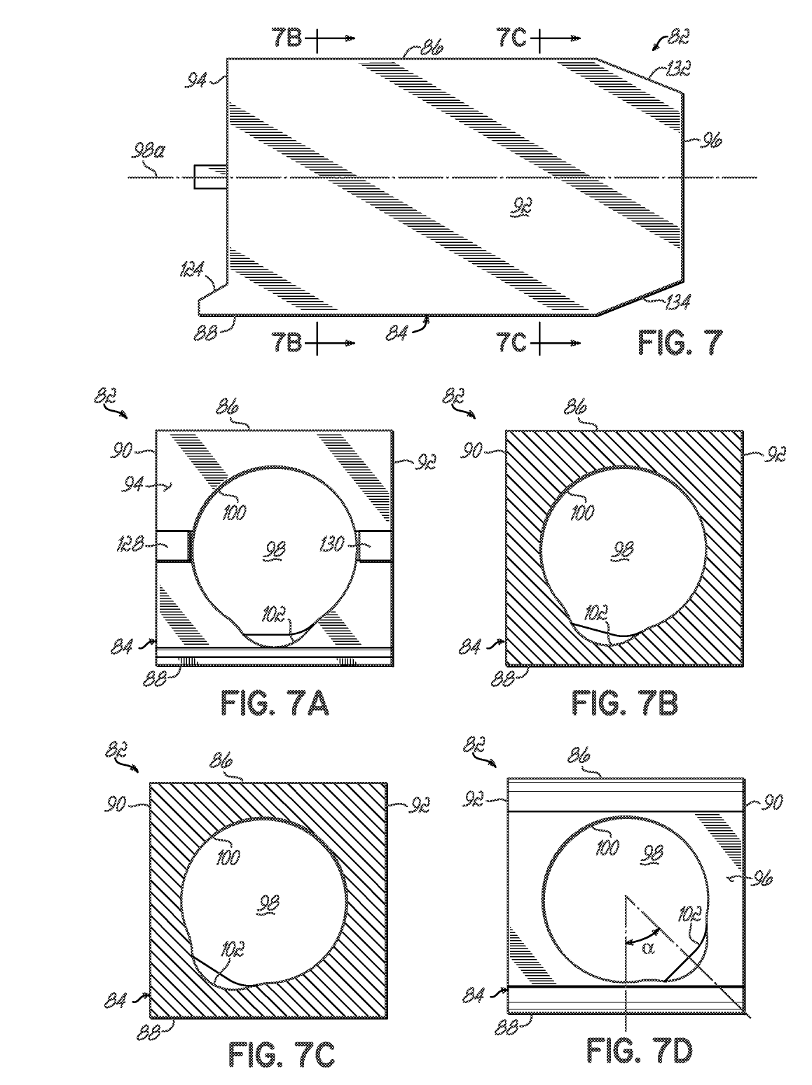

The construction of an exemplary loading guide 82 is best illustrated in FIGS. 5-7D. The loading guide 82 includes a generally rectangular body 84 having a top wall 86, a bottom wall 88, spaced apart rear and front walls 90, 92, and a pair of spaced apart end walls 94, 96. Each of the loading guides 82 also includes a channel 98 having an axis 98a extending in the transverse direction, i.e., substantially perpendicular to the machine direction (arrow 13). As shown in FIGS. 5 and 6, the channel 98 is adapted to align with channel 28 in a respective bucket 10 (i.e., where axis 28a is coaxial and/or substantially parallel to axis 98a). In particular, the floor of the channel 28 in bucket 10 is substantially at the same level as the floor of channel 98 in loading guide 82. Additionally, in cross section, channel 98 is adapted to correspond to the shape of the blister packs 30 in bucket 10. Accordingly, the channel 98 has a cross-sectional shape similar to that shown in FIG. 2A and includes a generally cylindrical portion 100 and a groove portion 102 (FIGS. 7A-7D). The groove portion 102 of channel 98 is adapted to receive the projecting tab 40 therein.

In one aspect of this embodiment, the loading guide 82 is configured to reorient the stack of blister packs 30 in bucket 10 for insertion into a carton 78 in a desired orientation. As mentioned above, the blister packs 30 may be deposited into the buckets 10 with the projecting tabs 40 pointing or facing downward. As also mentioned above, in order to minimize the amount of packaging material required for the cartons 78, it may be desirable to size the cartons 78 to be just slightly larger than the diameter D (FIG. 2A) of the upper flange 38 of the blister packs 30 so that the projecting tabs 40 have to be oriented to lie within a corner region of the carton 78 in order for the blister packs 30 to fit therein (FIG. 8). Because the cartons 78 are supported on the carton conveyor by a major panel 104 of the carton 78 (FIG. 4) lying horizontally, the blister packs 30 must be reoriented in known systems by rotating the stack of blister packs 30 prior to insertion into the cartons 78. The loading guides 82 described herein accomplish this reorientation in an improved manner.

With reference to FIGS. 5-7D, an opening 94a in end wall 94 is shaped so that the groove portion 102 of channel 98 aligns with and is at the same height as the groove 43 in lower portion 42 of channel 28. In this way, the groove portion 102 may receive the projecting tab 40 as configured in the buckets 10, i.e., in the downward facing position, as each blister pack 30 is moved from a bucket 10 to the loading guide 82. The groove portion 102 of channel 98 (shown as the hatched portion in FIG. 6) is not parallel to axis 98a through the channel 98, but is rather configured as a helical or spirally-directed path 106 that winds around the channel wall 108, defining channel 98. As the blister packs 30 are moved through the channel 98, such as a result of a force exerted by a pusher discussed in more detail below, the projecting tabs 40 engage groove portion 102 so as to rotate the blister packs 30 about axis 98a as the projecting tabs 40 move along helical path 106. Accordingly, the groove portion 102 provides a track along which projecting tabs 40 ride as blister packs 30 move through channel 98. An exemplary progression of rotating blister packs 30 is illustrated by the successive side and cross-sectional views shown in FIGS. 7A-7D.

With reference to FIG. 7A, the groove portion 102 is located at the bottom of channel 98 so as to receive the downward pointing projecting tabs 40 of blister packs 30 as they are received from the buckets 10 through opening 94a. As shown in FIG. 7B, the groove portion 102 has been rotated an amount in the clockwise direction about axis 98a (as viewed in FIG. 7B relative to sidewall 94). FIG. 7C shows the groove portion 102 rotated further in the same clockwise direction. Lastly, FIG. 7D shows a right side view of loading guide 82 wherein the groove portion 102 is no longer pointing downward, but has been rotated through an angle α (wherein the right side view of FIG. 7D relative to the views in FIGS. 7A-7C is counterclockwise). In the exemplary embodiment, the angle α is about 45 degrees. Those of ordinary skill in the art will recognize, however, that the amount the items, such as blister packs 30, are rotated in loading guides 82 depends on the specific application and the exemplary amount of rotation herein described is only illustrative and not intended to be limiting. With reference to FIGS. 6-7D, when the blister packs 30 exit loading guide 82 through opening 96a in end wall 96, each blister pack 30 has been sequentially rotated for packaging in a carton 78 with the projecting tabs 40 oriented to lie in a corner region of carton 78.

With reference to FIGS. 4-6, an overall operation of an exemplary handling apparatus will now be described. The blister packs 30 are filled and sealed at filling/sealing stations of an assembly line or system using suitably chosen apparatus well known in the art. The filled blister packs 30 are delivered to the bucket conveyor and deposited into the buckets 10 in a horizontal stack of, for example and without limitation, anywhere between about 5 and about 15 blister packs 30. The stack of blister packs 30 is at least in part supported in the buckets 10 by side guide(s) 76, tamp 58, or both, and the blister packs 30 are positioned so that projecting tabs 40 are in the downward facing direction and in groove 43 of buckets 10. The filled buckets 10 are conveyed in the machine direction to a cartoner for loading the stack of blister packs 30 into a suitable carton 78. To this end, the cartoner includes one or more stationary loading guides 82 (e.g., about 6 loading guides 82). The cartoner also includes a carton conveyor for transporting cartons 78 in the machine direction in registration with the buckets 10 on the bucket conveyor.

As the buckets 10 approach the cartoner, a point in the process is reached where side guide 76 no longer supports the stack and the blister packs 30 may be retained within the buckets 10 by a second side guide 110 (FIG. 4) associated with the loading guides 82. The second side guide 110 operates in a manner similar to side guide 76 in that side guide 110 may be adjustably positioned within notches 72, 74 so as to engage the end blister pack adjacent sidewall 18 and prevent, with the cooperation of lip 70 (or opposing side guide), any lateral movement of the stack of blister packs 30 along channel 28. Again, the position of side guide 110 within notch 72, 74 depends on the number of blister packs 30 in the stack. Side guide 110, however, includes blade guides (not shown) that traverse the channel 28 in the buckets 10. The blade guides are of a telescoping construction and capable of retractable movement in the machine direction and out of the channel 28 so that the blister packs 30 may be moved in the transverse direction out of buckets 10 and into the loading guides 82. Those of ordinary skill in the art will recognize that instead of the side guides 110 traversing the channel 28 from the sides, as shown in FIG. 4, the guides may be configured to engage the blister packs 30 from above. For example and without limitation, tamps 58 may include an access opening adjacent sidewall 18 to allow a retractable member to engage the blister packs 30 from above.

With continued reference to FIGS. 4-6, to move the stack of blister packs 30 from the buckets 10 on the bucket conveyor to the cartons 78 on the carton conveyor and through the loading guides 82, the cartoner includes a pusher 114 on one side of the bucket conveyor and a pusher 116 on a relatively opposed side of the carton conveyor (FIG. 4). The pushers 114, 116 are operable so as to move the stack of blister packs 30 in the transverse direction from the buckets 10 to the cartons 78. When the buckets 10 are aligned with the loading guides 82 and cartons 78, as shown in FIG. 4, pusher 114 moves right in the transverse direction to engage the left-most blister pack 30 (as viewed in FIG. 4) and pusher 116 moves left in the transverse direction to engage the right-most blister pack 30. The pushers 114, 116 provide lateral support that keeps the blister packs 30 in a stacked configuration during the transition from bucket 10 to carton 78. Once the pushers 114, 116 are engaged with the stack of blister packs 30, the pushers 114, 116 move to the right in unison to move the stack of blister packs 30 out of the bucket 10. When the pushers 114, 116 engage the blister packs 30 to provide lateral support, the blade guides on second side guide 110 retract so as to clear the channel 28 and allow the transverse movement of the blister packs 30 with movement of pushers 114, 116.

The pushers 114, 116 are also operative to move the stack of blister packs 30 through the loading guides 82. As explained above, as the blister packs 30 move through channel 98, the blister packs 30 are rotated about axis 98a by movement of the projecting tabs 40 along groove portion 102 that defines helical path 106. While the pushers 114, 116 maintain the blister packs 30 in the stacked configuration, rotation of a blister pack 30 relative to a blister pack 30 adjacent thereto is facilitated such that individual blister packs 30 rotate relative to one another as they move through channel 98. More particularly, the stack of blister packs 30 is not rotated as a bulk unit, but instead each of the blister packs 30 in the stack is sequentially rotated as the stack moves through channel 98.

With continued reference to FIGS. 4-6, once the blister packs 30 have been moved through the loading guides 82, the blister packs 30 have been rotated by a desired amount (e.g. about 45 degrees) so as to reorient the projecting tabs 40 to a desired position. With the projecting tabs 40 reoriented, the pushers 114, 116 then move the stack of blister packs 30 into the carton 78. As shown in FIG. 4, the carton 78 includes an end panel 118 that is open so as to receive the blister packs 30 as they are moved from the loading guides 82. The carton 78 also includes an opposed end panel 120 that is at least partially open so as to allow pusher 116 to move therethrough. For instance, end panel 120 may include a first pair of flaps that are glued during an erecting stage and which provide an access opening to receive pusher 116 therethrough. After the stack of blister packs 30 is loaded into the carton 78, the pushers 114, 116 are retracted. The filled carton 78 may then be conveyed downstream (i.e., in the machine direction) for flap closing and gluing. As shown in FIG. 8, by rotating the blister packs 30 by a specified amount (e.g., about 45 degrees), the projecting tabs 40 are positioned in a corner region of carton 78.

With particular reference to FIG. 4, the cartoner may include a side guide 122 (FIG. 4) associated with the carton conveyor along which cartons 78 move after being loaded. The side guide 122 is positioned adjacent the opening in end panel 118 so as to prevent the blister packs 30 from falling out of the cartons 78 as they are conveyed downstream. The first pair of flaps in end panel 120 is adapted to prevent the blister packs 30 from falling out of this end of the carton as the cartons are conveyed downstream. Those of ordinary skill in the art will recognize, however, that alternatively another side guide (not shown) associated with the carton conveyor may be used to prevent the blister packs 30 from falling out of this end of the carton.

In another aspect of this exemplary embodiment, the various components may include one or more interlocking features that prevent the blister packs 30 from dropping into spaces or gaps between the components. For instance, and as best shown in FIG. 4, there may be a gap 123 between the buckets 10 and the loading guides 82. There may also be a gap 125 between the loading guides 82 and the cartons 78. As shown in FIGS. 5-7, to prevent any movement of the blister packs 30 into the gap 123 between the bucket 10 and the loading guide 82, the loading guide 82 includes a bottom lip 124 protruding from end wall 94. Additionally, the bottom wall 20 of bucket 10 adjacent sidewall 18 includes a bevel 126. When a bucket 10 is aligned with a loading guide 82, the bottom lip 124 protrudes under the opening in sidewall 18 and adjacent taper 126. In this way, blister packs 30 moving between the bucket 10 and loading guide 82 are prevented from dropping downward into the gap 123 therebetween. Furthermore, loading guide 82 may include a pair of tabs 128, 130 (FIGS. 4-5) protruding from sidewall 94 and adjacent the opening 94a therein. The tabs 128, 130 are received in the notches 72, 74 in buckets 10 as shown in FIGS. 5 and 6. The tabs 128, 130 prevent any movement of the blister packs 30 in the machine direction and into the gap 123 between the buckets 10 and the loading guides 82.

With reference to FIGS. 4-7, the loading guide 82 includes a downward bevel 132 in the top wall 86 and an upward bevel 134 in the bottom wall 88. As best shown in FIG. 4, an upper flap 136 in end panel 118 of carton 78 is configured to overlie bevel 132. In a similar manner, a lower flap 138 in end panel 118 of carton 78 is configured to underlie bevel 134. The respective cooperation between the flaps 136, 138 on the carton 78 and the bevels 132, 134 in loading guide 82 close the gap 125 therebetween.

While the present invention has been illustrated by a description of various preferred embodiments and while these embodiments have been described in some detail, it is not intended to restrict or in any way limit the scope of the appended claims to such detail. For example, as noted above, while the above description of embodiments of the invention was directed to the packaging of blister packs in a carton, those of ordinary skill in the art will recognize that the same principles may be used in the packaging of other items that would benefit from the teachings herein. Accordingly, the principles taught herein may be utilized to package an item or stack of items for which reorientation of the item(s) is desired prior to insertion into a carton.

Moreover, while the embodiments of the invention have been shown and described as applicable to a tab on the item(s) cooperating with a groove in the loading guide to accomplish such reorientation of the item(s), these embodiments are not intended to be limiting. Those of ordinary skill in the art will recognize that items have or may be configured to have other features that may be utilized to accomplish reorientation of the item(s). For example, the item(s) may include a groove that cooperates with a helical ridge in the loading guide to rotate the item(s) by a desired amount. Thus, the invention is not limited to the tab/groove features described herein, but encompasses other features on the item and loading guide to accomplish rotation of the item(s) to achieve a desired orientation. Thus, additional advantages and modifications will readily appear to those skilled in the art. The various features herein described may be used alone or in numerous combinations depending on the needs and preferences of the user.

What is claimed is:

1. An apparatus for transferring and reorienting a blister pack for packaging into a carton, comprising:
a body having a first end and a second end; and
a channel formed in said body extending between said first and second ends, and defining a channel axis, said channel configured to receive the blister pack at said first end when the blister pack is in a first angular orientation relative to said channel axis, said channel configured to deliver the blister pack at said second end in a second angular orientation relative to said channel axis different from said first angular orientation.

2. The apparatus of claim 1, wherein said channel further comprises a groove extending between said first and second ends and formed in a wall of said channel, said groove being configured to engage a projecting tab of the blister pack and rotate the blister pack from said first angular orientation to said second angular orientation as the blister pack moves from said first end to said second end.

3. The apparatus of claim 2, wherein said groove is further configured to engage a generally downward-pointing projecting tab of the blister pack at said first end.

4. The apparatus of claim 2, wherein said groove is further configured to rotate the blister pack about 45 degrees as the blister pack travels from said first end to said second end.

5. A handling apparatus for transporting, reorienting and transferring a stack of blister packs for packaging into a carton, the apparatus comprising:
a bucket configured for movement in a machine direction and including a bucket channel having a bucket channel axis substantially perpendicular to the machine direction, said bucket channel being configured to receive the stack of blister packs therein with the blister packs being in a first angular orientation; and
a loading guide disposed between said bucket and the carton, said loading guide including a first end adjacent said bucket, a second end adjacent the carton, and a loading guide channel extending between the first and second ends, said loading guide channel configured to receive the stack of blister packs from said bucket at said first end when the blister packs are in said first angular orientation, said loading guide channel configured to deliver the blister packs to the carton at said second end in a second angular orientation different from said first angular orientation.

6. The handling apparatus of claim 5, further comprising:
a groove formed in a wall of said loading guide channel, said groove configured to engage a projecting tab of the blister packs and rotate the blister packs about said loading guide channel axis from said first angular orientation to said second angular orientation as the blister packs move from said first end to said second end.

7. The handling apparatus of claim 6, wherein said groove is further configured to engage a generally downward-pointing projecting tab of the blister pack at said first end.

8. The handling apparatus of claim 5, wherein said bucket channel includes a cross-sectional shape that at least in part corresponds to a shape of the blister pack.

9. The handling apparatus of claim 5, wherein said loading guide channel includes a cross-sectional shape that substantially corresponds to a shape of the blister pack.

10. The handling apparatus of claim 9, wherein said cross-sectional shape at said first end corresponds to the shape of the blister pack when the blister pack is in the first angular orientation.

11. The handling apparatus of claim 6, wherein said groove is further configured to rotate the blister pack about 45 degrees as the blister pack travels from said first end to said second end.

12. The handling apparatus of claim 5, further comprising:
a notch in said bucket and extending generally in a second direction transverse to the machine direction; and
a side guide received within said notch and configured to provide lateral support to the stack of blister packs in said bucket.

13. The handling apparatus of claim 12, wherein said side guide is adjustable within the notch and along said second direction to accommodate various sizes of the stack in said bucket.

14. The handling apparatus of claim 5 further comprising:
a pusher configured to advance the blister pack along said bucket channel and into the carton.

15. An apparatus for transferring and reorienting an item for packaging into a carton, comprising:
a body having a first end and a second end; and
a channel formed in said body extending between said first and second ends, and defining a channel axis, said channel configured to receive the item at said first end when the item is in a first angular orientation relative to said channel axis, said channel configured to deliver the item at said second end in a second angular orientation relative to said channel axis different from said first angular orientation.

16. A handling apparatus for transporting, reorienting and transferring a stack of items for packaging into a carton, the apparatus comprising:
a bucket configured for movement in a machine direction and including a bucket channel having a bucket channel axis substantially perpendicular to the machine direction, said bucket channel being configured to receive the stack of items therein with the items being in a first angular orientation relative to said bucket channel axis; and
a loading guide disposed between said bucket and the carton, said loading guide including a first end adjacent said bucket, a second end adjacent the carton, and a loading guide channel extending between the first and second ends, said loading guide channel configured to receive the stack of items at said first end when the items are in said first angular orientation, said loading guide channel configured to deliver the items at said second end in a second angular orientation different from said first angular orientation.

17. A method of handling a blister pack for packaging into a carton, the method comprising:
depositing the blister pack into a bucket configured to move in a machine direction;
moving the bucket in the machine direction;
moving the blister pack in a second direction along an axis transverse to the machine direction through a loading guide in operative communication with the bucket and the carton;
reorienting the blister pack from a first angular orientation relative to the axis to a second angular orientation relative to the axis different from the first angular orientation as the blister pack moves from a first end of the loading guide to a second end thereof.

18. The method of claim 17, wherein depositing the blister pack into a bucket includes depositing the blister pack in the first angular orientation.

19. The method of claim 18, wherein depositing the blister pack into the bucket in the first angular orientation includes depositing the blister pack such that a projecting tab of the blister pack points generally downward.

20. The method of claim 17, wherein reorienting the blister pack further comprises:
engaging a projecting tab of the blister pack with a feature formed in a channel of the loading guide, the feature operative to rotate the blister pack about the axis as the blister pack moves through the channel.

21. The method of claim 17, wherein reorienting the blister pack from the first angular orientation to the second angular orientation includes rotating the blister pack about 45 degrees about the axis from the first angular orientation.

22. The method of claim 17, further comprising:
moving the blister pack in the second direction while supporting the blister pack from opposed sides along the axis.

23. The method of claim 17, further comprising:
sequentially reorienting a plurality of the blister packs in a stacked arrangement from the first angular orientation to the second angular orientation as the blister packs move through the loading guide.

24. A method of handling an item for packaging into a carton, the method comprising:
depositing the item into a bucket configured to move in a machine direction;
moving the bucket in the machine direction;
moving the item in a second direction along an axis transverse to the machine direction through a loading guide in operative communication with the bucket and the carton;
reorienting the item from a first angular orientation relative to the axis to a second angular orientation relative to the axis different from the first angular orientation as the item moves from a first end of the loading guide to a second end thereof.
